(19) United States
(12) Patent Application Publication
(10) Pub. No.: US 2011/0075679 A1
(43) Pub. Date: Mar. 31, 2011

(54) PACKET TRANSMISSION DEVICE AND PACKET TRANSMISSION METHOD

(75) Inventor: Tomohiro Yui, Kanagawa (JP)

(73) Assignee: PANASONIC CORPORATION, Osaka (JP)

(21) Appl. No.: 12/995,861

(22) PCT Filed: Jun. 16, 2009
(86) PCT No.: PCT/JP2009/002740

§ 371 Date: Dec. 2, 2010

(30) Foreign Application Priority Data
Jun. 26, 2008 (JP) 2008-167715

(51) Int. Cl. H04L 12/56

(52) U.S. Cl. 370/412

(57) ABSTRACT

Provided are a packet transmission device and a packet transmission method which can effectively use a radio band while suppressing a processing overhead. A packet transmission device (100) includes: a transmission path judgment unit (110) which judges a transmission path state according to a radio channel quality estimation result; and an adaptive scheduler unit (108) which includes a low QoS packet into a transmission frame constituent element with a higher priority if the transmission path state is judged to be bad and a high QoS packet into the transmission frame constituent element with a higher priority if the transmission path state is judged to be good. That is, the adaptive scheduler unit (108) allocates a low QoS packet with a higher priority when it is judged that the possibility of generation of a radio error is high and the transmission path state is bad.

### TECHNICAL FIELD

The present invention relates to a packet transmitting apparatus and a packet transmitting method for digital mobile communication to allow packet communication.

### BACKGROUND ART

Conventionally, in the field of radio communication systems, a communication scheme referred to as “HSDPA” has been standardized whereby a plurality of communication terminal apparatuses share high speed and large capacity downlink channels to perform high-speed packet transmission in the downlink, besides communication schemes that performs transmission to communication terminal apparatuses using DPCHs (dedicated physical channels).

In radio communication, propagation conditions are significantly unstable, and the capacity of communication channels widely changes over time. HSDPA (High Speed Downlink Packet Access) uses this. HSDPA is a technique of performing high-speed transmission using M-ary modulation and low coding rate when communication conditions are good, in order to improve peak throughput.

In this HSDPA system, a base station apparatus has signals referred to as “CQIs (channel quality indicators)” transmitted from communication terminal apparatuses, where CQIs indicate modulation schemes and coding rates of packet data that can be demodulated in communication terminal apparatuses. Upon receiving a CQI, the base station apparatus performs scheduling using the CQI transmitted from each communication terminal apparatus and selects the optimal modulation scheme, coding rate and so forth. Then, the base station apparatus modulates and encodes transmission data using the selected modulation scheme, coding rate and so forth, and transmits data to each communication terminal apparatus, based on the scheduling result. By this means, transmission rates are adaptively changed depending on radiowave propagation environments, so that HSDPA makes it possible to transmit a larger capacity of data from a base station apparatus to communication terminal apparatuses than DPCH.

In addition, in this HSDPA system, communication terminal apparatuses transmit an ACK/NACK signal indicating whether or not a downlink packet referred to as “HS-PDSCH (high speed physical downlink shared channel)” could be received, and CQI signals over an HS-DPCCH (dedicated physical control channel (uplink) for HS-DSCHs.) With this method, an HS-DPCCH is code-multiplexed with a DPCCH (dedicated physical control channel) and a DPDCH (dedicated physical data channel), and transmitted.

A transmitter in digital mobile communication to allow packet communication generates radio errors, including possible fading in radio channels; a frequency error due to Doppler frequency that may be caused by movement of a mobile device; deterioration of receiving sensitivity that may be caused by being away from a base station. By these radio errors, cases might occur where a receiver cannot correctly decode a radio frame transmitted from a transmitter and obtain a packet contained in the radio frame.

A HARQ (Hybrid ARQ) technique is a retransmission scheme in which, when a radio frame that could not be correctly decoded as described above is detected, a retransmission request is made to the transmitter side and the radio frame that could not be decoded is held in the receiver side, and then, when a radio frame retransmitted from the transmitter is received, the held radio frame received last time and that retransmitted frame are combined, and reinforced with redundant bits to decode the radio frame. In the field of digital mobile communication, HARQ has been adopted in digital mobile telephone standards to allow high-speed packet communication, and is being adopted, for example, in mobile telephones in compliance with the HSPA standard centered around Japan and also in mobile telephones in compliance with the EDGE standard centered around Europe. In addition, HARQ is due to be adopted in the next generation high-speed packet communication standard 3G-LTE (Long Term Evolution), standardization of which is underway.

The above-described HARQ technique is essential to realization of high-speed packet communication. A radio frame decoding failure due to a radio error creates a problem that a huge amount of processing time is required to perform a sequential additional processing, including transmission processing to make retransmission request from a receiver to a transmitter; retransmission frame construction processing upon receiving the retransmission request; retransmission processing to retransmit from the transmitter; and reception processing upon receiving a retransmission frame.

To address the above-described problem of processing time, it has been proposed to reduce frequency of occurrence of retransmissions requiring processing time by adjusting transmission timings depending on the moving speed of a mobile device and by performing asynchronous transmission depending on radio channel conditions when the mobile device moves at a low speed (for example, see Patent Literature 1.) However, if a radio channel condition is poor, it is anticipated that radio bands are wasted and synchronization processing overhead due to asynchronous transmission increases.

FIG. 1 is a block diagram showing a configuration of a conventional packet transmitting apparatus.

In FIG. 1, packet transmitting apparatus 10 has RF processing section 11, baseband processing section 12, retransmission control section 13, retransmission buffer section 14, frame analysis section 15, reception buffer sections 16-1 to 16-N, frame assembling section 17, scheduler section 18, and transmission buffer sections 19-1 to 19-N.

RF processing section 11 converts a digital signal radio frame to an analog signal radio frame, and sends the result from radio antenna 11a by radio. In addition, RF processing section 11 converts an analog signal radio frame transmitted by radio to a digital signal radio frame.

Baseband processing section 12 performs demodulation and decoding processing on a received signal having been converted to a radio frame by RF processing section 11, and outputs a transmission packet delivery acknowledgement signal and a received packet from a counterpart receiving apparatus, which are obtained by the demodulation and decoding processing, to retransmission control section 13. In addition, baseband processing section 12 performs coding and modulation processing on a transmission radio frame outputted from retransmission control section 13, and transmits the result via RF processing section 11 by radio.

Retransmission control section 13 sends a transmission radio frame from frame assembling section 17, or, when a retransmission request is made, sends a retransmission radio frame from retransmission buffer section 14 to baseband processing section 102 at the time the retransmission radio frame should be transmitted, and holds it in retransmission buffer section 14 until receiving a delivery acknowledgement from a counterpart receiver.

Frame analysis section 15 analyzes protocol header information of a radio frame to store a received packet and specifies the position and logical channel information of the received packet.

Reception buffer sections 16-1 to 16-N accumulate received packets specified in frame analysis section 15, in association with logical channel information.

Frame assembling section 17 assembles a radio frame in accordance with a frame format, based on transmission frame components determined in the above scheduler section.

Scheduler section 18 determines transmission frame components from the above transmission buffer sections, based on a scheduling method.

Transmission buffer sections 19-1 to 19-N accumulate transmission packets associated with service quality (QoS.)

FIG. 2 is a drawing explaining packet transmission delay time when the above packet transmitting apparatus 10 is applied. In FIG. 2, numbers on the horizontal axis represent radio frames transmitted from a transmission source transmitter, and radio frames received by a reception source receiver.

In FIG. 2, packets are transmitted from a transmission source transmitter (packet transmitting apparatus 10) having the configuration shown in FIG. 1.

As shown in FIG. 2a., when a radio error occurs in a fifth radio frame, the counterpart reception source receiver side detects occurrence of the radio error (see FIG. 2b.). The reception source receiver reports the detection result to a reception source transmitter (see FIG. 2c.), and then the reception source transmitter generates and transmits NACK information (see FIG. 2D.).

A transmission source receiver detects the NACK information (see FIG. 2e.), and reports the detection result to a transmission source transmitter (see FIG. 2f.). Upon receiving this, the transmission source receiver retransmits the fifth radio frame in which a radio error has occurred (see FIG. 2g.).

The reception source transmitter recognizes that a delivery failure has occurred in the above process. This process includes a radio transmission delay (see FIG. 2h.) to transmit radio frames from the transmission source to the reception source receiver, and a processing delay in the reception source (see FIG. 2i.) in order that the reception source receiver receives radio frames, performs demodulation and decoding processing, reports the error detection result to the reception source receiver, generates NACK information and performs coding and modulation processing. In addition, there are a transmission delay (see FIG. 2j.) to transmit radio frames containing NACK information from the reception source transmitter transmits to transmission source transmitter, and a processing delay in the transmission source (see FIG. 2k.) in order that the transmission source receiver receives radio frames, performs demodulation and decoding processing, detects NACK information and reports the detection result to the transmission source transmitter. These processing delays are totalized, and in addition, when transmission is performed at the timing in synchronization with the reception source side, a waiting time to wait for the synchronized timing (see FIG. 2l.) is added.

### Citation List

### Patent Literature

### [PTL 1]

Patent 2007-318764

### SUMMARY OF INVENTION

### Technical Problem

However, with this conventional packet transmitting apparatus, when radio communication conditions are poor, it is anticipated that radio bands are wasted, and synchronization processing overhead due to asynchronous transmission increases.

In addition, when a mobile terminal is supposed to process services requiring low delay typified by VoIP voice call and process services requiring high transmission rate typified by FTP download at the same time, there is a problem to be solved to assure the quality at the time of occurrence of retransmission under a poor transmission channel condition, that is, to allow high transmission rate with low delay.

It is therefore an object of the present invention to provide a packet transmitting apparatus and a packet transmitting method to allow efficient use of radio bands while reducing processing overhead.

### Solution to Problem

The packet transmitting apparatus according to the present invention adopts a configuration to include: a transmission buffer section that accumulates transmission packets associated with service quality (QoS); a baseband processing section that estimates radio channel quality by demodulation and decoding processing; a transmission channel judgment section that judges a transmission channel condition, based on a radio channel quality estimation result from the baseband processing section; an adaptive scheduler section that selects one of a plurality of scheduling methods based on the transmission channel condition from the transmission channel judgment section, and determines transmission frame components in transmission packets accumulated in the transmission buffer section; a frame assembling section that assembles a radio frame in compliance with a frame format, based on the transmission frame components determined in the adaptive scheduler section; and a retransmission control section that sends a transmission radio frame from the frame assembling section, or, when a retransmission request is made, sends a retransmission radio frame from a retransmission buffer to the baseband processing section, and holds the transmission radio frame or the retransmission radio frame in the retransmission buffer until receiving a delivery acknowledgement from a counterpart receiver. When the transmission channel judgment section judges that the transmission channel condition is poor, the adaptive scheduler section preferentially includes a low service quality packet in the transmission frame components, and, when the transmission channel judgment section judges that the transmission channel condition is good, preferentially includes a high service quality packet in the transmission frame components.

The packet transmitting method according to the present invention includes the steps of: accumulating transmission packets associated with service quality; estimating radio channel quality by demodulation and decoding processing; judging a transmission channel condition based on an estimation result of the radio channel quality; selecting one of a plurality of scheduling methods based on the transmission channel condition and determining transmission frame components of the transmission packets accumulated, based on the selected scheduling method; assembling a radio frame in compliance with a frame format based on the determined transmission frame components; and sending a transmission radio frame, or, when a retransmission request is made, sending a retransmission radio frame, and holding the transmission frame or the retransmission frame in the retransmission buffer until a delivery acknowledgement is received from a counterpart receiver. When the transmission channel condition is judged to be poor, a low service quality packet is preferentially included in transmission frame components, and, when the transmission channel condition is judged to be good, a high service quality packet is preferentially included in the transmission frame components.

### Advantageous Effects of Invention

According to the present invention, when a transmission channel conditions is judged to be poor, low QoS packets are preferentially included in transmission frame components, and, on the other hand, when a transmission channel condition is judged to be good, high QoS packets are preferentially included in transmission frame components. By this means, it is possible to prevent increase in delay time until high QoS packets arrive and prevent deterioration of communication quality due to radio errors, and also realize a packet transmitting apparatus to keep the transmission rate of low QoS packets.

### BRIEF DESCRIPTION OF DRAWINGS

FIG. 1 is a block diagram showing a configuration of a conventional packet transmitting apparatus;

FIG. 2 is a drawing explaining packet transmission delay time when the conventional packet transmitting apparatus is applied;

FIG. 3 is a block diagram showing a configuration of a packet transmitting apparatus according to Embodiment 1 of the present invention;

FIG. 4 shows a circuit configuration of a simplified transmission channel judgment section in the packet transmitting apparatus according to Embodiment 1;

FIG. 5 shows a circuit configuration of a high-precision transmission channel judgment section in the packet transmitting apparatus according to Embodiment 1;

FIG. 6 shows a circuit configuration of the simplified transmission judgment section with the number of times of retransmissions control in the packet transmitting apparatus according to Embodiment 1;

FIG. 7 shows a circuit configuration of the high-precision transmission channel judgment section with control of the number of times of retransmissions in the packet transmitting apparatus according to Embodiment 1;

FIG. 8 shows a configuration of a simplified adaptive scheduler section in the packet transmitting apparatus according to Embodiment 1;

FIG. 9 shows a circuit configuration of a duplicate transmission in the packet transmitting apparatus according to Embodiment 1;

FIG. 10 is a drawing explaining packet transmission delay time when the packet transmitting apparatus according to Embodiment 1 is applied;

FIG. 11 is a block diagram showing a configuration of a packet transmitting apparatus according to Embodiment 2 of the present invention; and

FIG. 12 is a drawing explaining packet transmission delay time when the packet transmitting apparatus according to Embodiment 2 is applied.

### DESCRIPTION OF EMBODIMENTS

Now, embodiments of the present invention will be described in detail with reference to the accompanying drawings.

### Embodiment 1

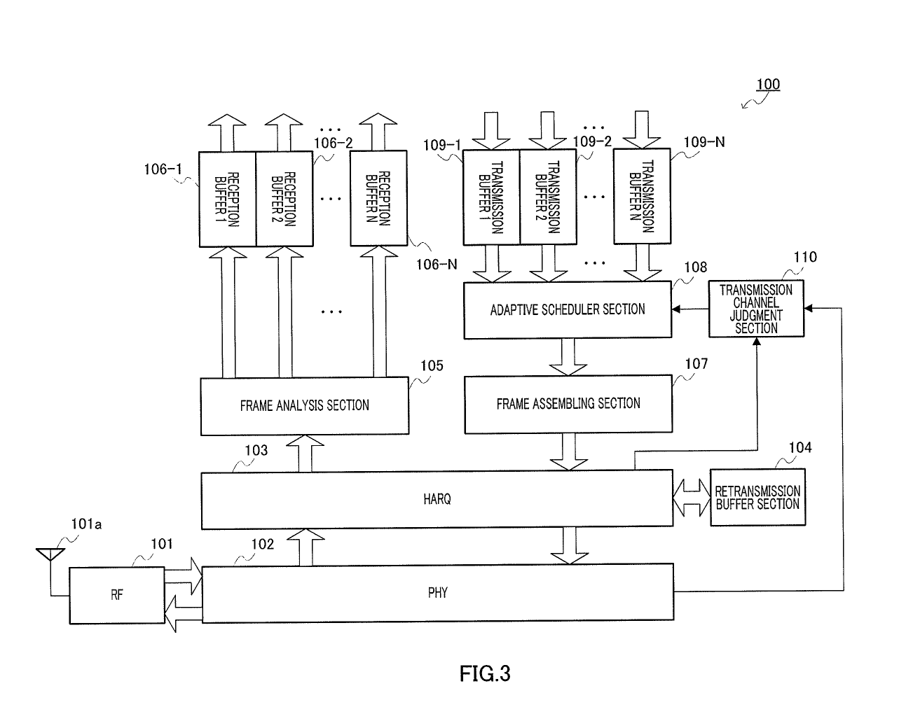

FIG. 3 is a block diagram showing a configuration of a packet transmitting apparatus according to Embodiment 1 of the present invention. The present embodiment is an example of a case in which the packet transmitting apparatus is a digital mobile communication apparatus.

In FIG. 3, packet transmitting apparatus 100 is configured to include RF processing section 101, baseband processing section 102 (abbreviated as “PHY” in FIG. 3), retransmission control section 103 (abbreviated as “HARQ” in FIG. 3), retransmission buffer section 104, frame analysis section 105, reception buffer sections 106-1 to 106-N, frame assembling section 107, adaptive scheduler section 108, transmission buffer sections 109-1 to 109-N and transmission channel judgment section 110.

RF processing section 101 converts a digital signal radio frame to an analog signal radio frame, and sends the result from radio antenna 101a by radio. In addition, RF processing section 101 converts an analog signal radio frame by radio to a digital signal radio frame.

Baseband processing section 102 performs demodulation and decoding processing on the received signal having been converted to a radio frame by RF processing section 101, and outputs a transmission packet delivery acknowledgement signal and a received packet from a counterpart receiving apparatus, which are obtained by the demodulation and decoding processing, to retransmission control section 103. In addition, baseband processing section 102 performs coding and modulation processing on a transmission radio frame outputted from retransmission control section 103, and transmits the result via RF processing section 101 by radio. In addition, baseband processing section 102 estimates radio channel quality by modulation and decoding processing and outputs the radio channel quality estimation result to transmission channel judgment section 110.

Retransmission control section 103 sends a transmission radio frame from frame assembling section 107, or, when a retransmission request is made, sends a retransmission radio frame from retransmission buffer section 104 to baseband processing section 102 at the time the retransmission radio frame should be transmitted, and holds it in retransmission buffer section 104 until receiving a delivery acknowledgment from a counterpart receiver. In addition, retransmission control section 103 outputs the radio channel quality estimation result to transmission channel judgment section 110.

Frame analysis section 105 analyzes protocol header information of a radio frame to store a received packet and specifies the position and logical channel information of the received packet. Frame analysis section 105 receives radio frames with no error from retransmission control section 103, assign storage buffers based on information (e.g. channel ID) in frames and stores them in reception buffer sections 106-1 to 106-N.

Reception buffer sections 106-1 to 106-N accumulate received packets having been specified in frame analysis section 105, in association with logical channel information.

Frame assembling section 107 assembles a radio frame in accordance with a frame format, based on transmission frame components determined by adaptive scheduler section 108.

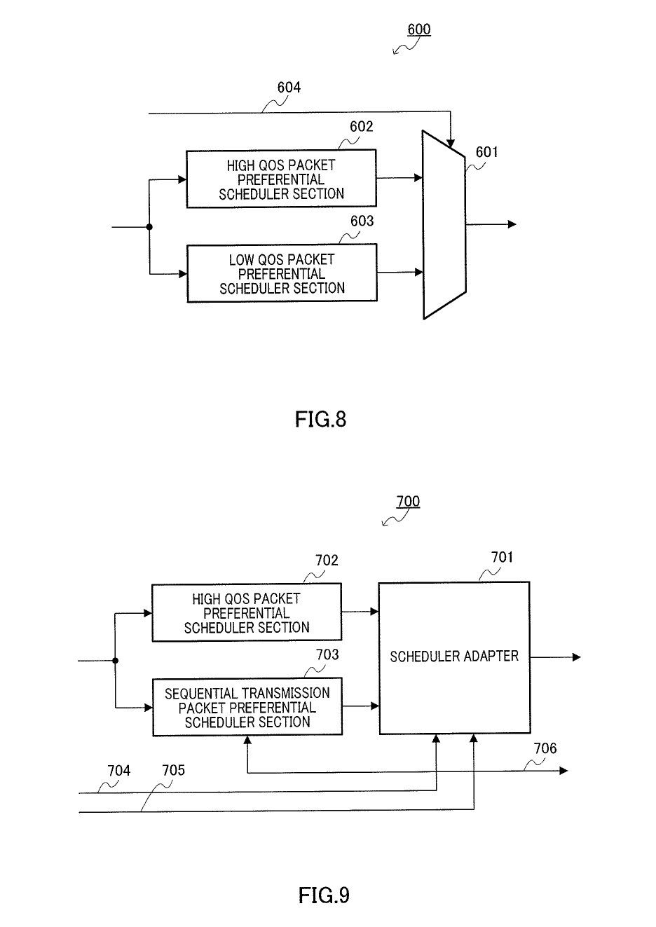

Adaptive scheduler section 108 selects one of a plurality of scheduling methods, based on a transmission channel condition from transmission channel judgment section 110, and determines transmission frame components of transmission packets accumulated in transmission buffer sections 109-1 to 109-N, based on the selected scheduling method. A transmission frame component is a packet or part of a packet. Since packets are stored in transmission buffer sections 109-1 to 109-N, packets themselves are transmission frame components. To be more specific, when transmission channel judgment section 110 judges that a transmission channel condition is poor, adaptive scheduler section 108 preferentially includes low QoS packets in transmission frame components, and, when transmission channel judgment section 110 judges that a transmission channel condition is good, preferentially includes high QoS packets in transmission frame components. The circuit configuration of adaptive scheduler section 108 will be described in detail later, with reference to FIG. 8 and FIG. 9.

Transmission buffer sections 109-1 to 109-N accumulate transmission packets associated with service quality (QoS.)

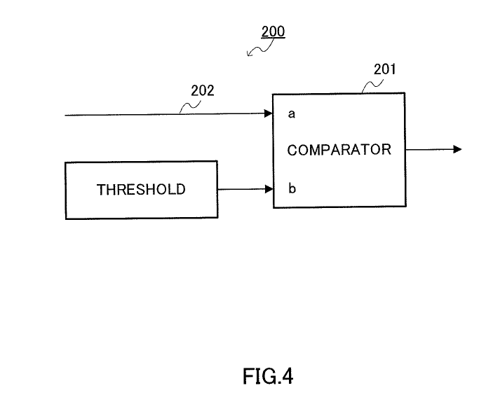

Transmission channel judgment section 110 judges transmission channel conditions, based on radio channel quality estimation results from baseband processing section 102 and retransmission frame information from retransmission control section 103. The circuit configuration of transmission channel judgment section 110 will be described in detail as follows, with reference to FIG. 4 to FIG. 7.

FIG. 4 shows a circuit configuration of a simplified transmission channel judgment section 110. Simplified transmission channel judgment section 200 is used as a simple version of transmission channel judgment section 110 in FIG. 3.

In FIG. 4, simplified transmission channel judgment section 200 includes comparator 201.

Comparator 201 compares received bit error rate estimation value 202 of radio channel quality estimation results from baseband processing section 102 (FIG. 3), with a preset threshold.

When the bit error rate estimation value is greater than the preset threshold, simplified transmission channel judgment section 200 outputs an indication that the transmission channel condition is poor.

This simplified transmission channel judgment section 200 can judge whether transmission channel conditions are good or poor with relatively a little amount of processing.

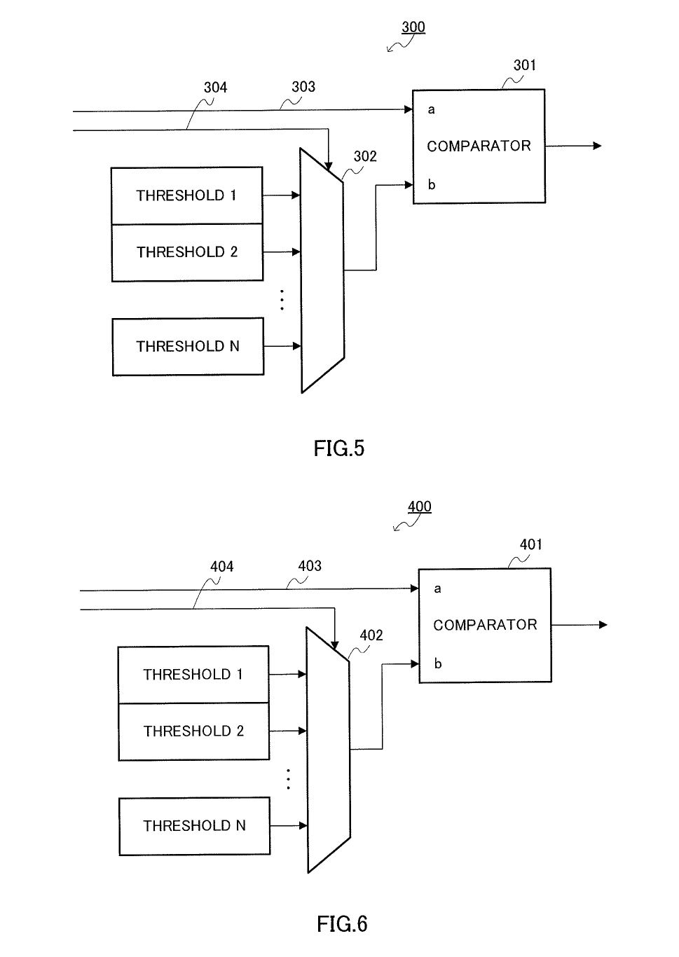

FIG. 5 shows a circuit configuration of a high-precision transmission channel judgment section 110. High-precision transmission channel judgment section 300 is used as a high-precision version of transmission channel judgment section 110 in FIG. 3.

In FIG. 5, high-precision transmission channel judgment section 300 is composed of comparator 301 and selector 302. Input port a in comparator 301 receives, as input, received power level estimation value 303 of radio channel quality estimation results from baseband processing section 102 (FIG. 3.) In addition, input port b in comparator 301 receives a threshold selected by selector 302 as input.

Selector 302 selects an appropriate threshold from thresholds 1, 2, . . . , N that are preset every certain frequency error estimation value range, based on frequency error estimation value 304 inputted.

Comparator 301 compares received power level estimation value 303 with the threshold selected by selector 302.

As described above, in high-precision transmission channel judgment section 300, selector 302 selects the threshold from frequency error estimation value 304, and, when received power level estimation value 303 is lower than the selected threshold, comparator 301 outputs an indication that the transmission channel condition is poor.

This high-precision transmission channel judgment section 300 can judge precisely whether transmission channel conditions are good or poor more than simplified transmission channel judgment section 200 in FIG. 4.

Reception sensitivity of a mobile device varies, for example, when a mobile device does not move, moves and moves fast. The reception power level threshold is changed using a frequency error due to Doppler frequency caused by the moving speed of a mobile device as frequency error estimation value 304. By this means, it is possible to judge more precisely whether transmission channel conditions are good or poor.

FIG. 6 is a circuit configuration of simplified transmission channel judgment section 110 with control of the number of times of retransmissions. Simplified transmission channel judgment section 400 with control of the number of times of retransmissions is used as simplified transmission channel judgment section 110 with control of the number of times of retransmissions shown in FIG. 3.

In FIG. 6, simplified transmission channel judgment section 400 with control of the number of times of retransmissions is composed of comparator 401 and selector 402. Input port a in comparator 401 receives, as input, bit error rate estimation value 403 of radio channel quality estimation results from baseband processing section 102 (FIG. 3.) In addition, input port b in comparator 401 receives a threshold selected by selector 402 as input.

Selector 402 selects an appropriate threshold from thresholds 1, 2, . . . , N preset by the number of times of retransmissions, based on the number of times of retransmissions 404 from retransmission control section 103 (FIG. 3.)

Comparator 401 compares bit error rate estimation value 403 with the threshold selected by selector 402.

As described above, in simplified transmission channel judgment section 400 with control of the number of times of retransmissions, selector 402 selects thresholds according to the number of times of retransmissions 404, and, when bit error rate estimation value 403 is greater than the selected threshold, comparator 401 outputs an indication that the transmission channel condition is poor.

HARQ is a technique to maximally derive coding gain by combining retransmission data with past transmission data accumulated in a counterpart receiver side, reinforcing redundancy and decoding the result, and therefore provides improved radio error robustness because of reinforcing redundancy at the time of retransmission. This allows delivery at the time of retransmission even if the transmission channel condition is poorer than at the time of the first transmission, and it is possible to reduce delay time until arrival more than in simplified transmission channel judgment section 200 in FIG. 4 by setting a threshold so as to increase the threshold according to the number of times of retransmissions 404.

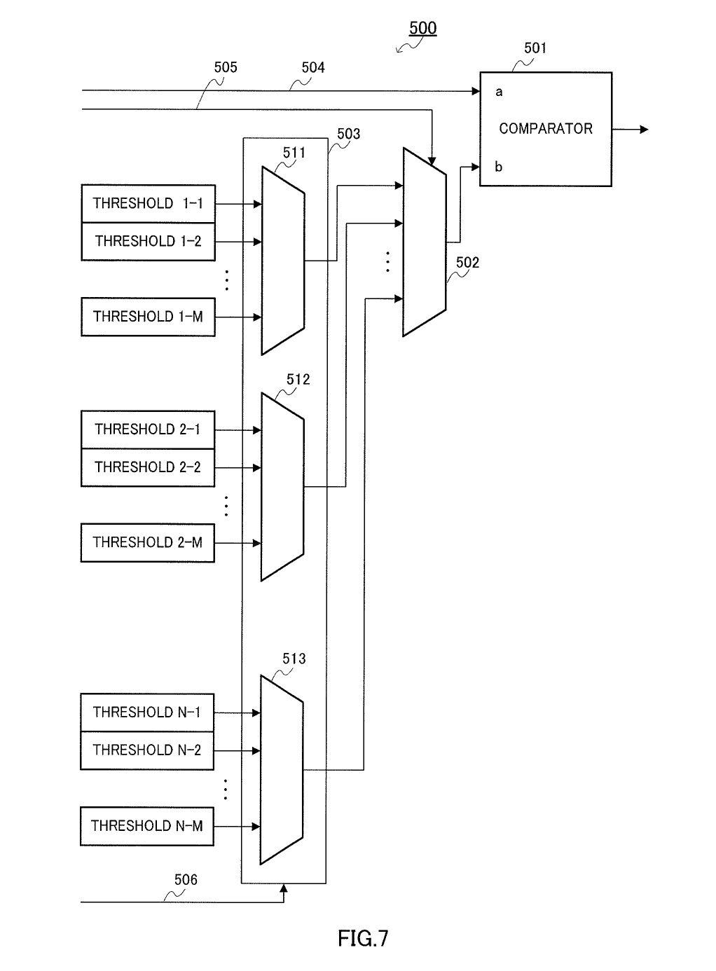

FIG. 7 shows a circuit configuration of high-precision transmission channel judgment section 110 with control of the number of times of retransmissions. High-precision transmission channel judgment section 500 with control of the number of times of retransmissions is used as a high-precision version of transmission channel judgment section 110 in FIG. 3, with control of the number of times of retransmissions. High-precision transmission channel judgment section 500 with control of the number of times of retransmissions has a configuration by combining high-precision transmission channel judgment section 300 in FIG. 5 and simplified transmission channel judgment section 400 with control of the number of times of retransmissions in FIG. 6.

In FIG. 7, high-precision transmission channel judgment section 500 with control of the number of times of retransmissions is configured to include comparator 501, selector 502 and retransmission count control selector 503. Input port a in comparator 501 receives, as input, received power level estimation value 504 of radio channel quality estimation results from baseband processing section 102 (FIG. 3.) In addition, input port b in comparator 501 receives a threshold selected by selector 502 as input.

Retransmission count control selector 503 is composed of selector 511 that selects an appropriate threshold from thresholds 1-1, 1-2, . . . , 1-M, selector 512 that selects an appropriate threshold from thresholds 2-1, 2-2, . . . , 2-M and selector 513 that selects an appropriate threshold from thresholds N-1, N-2, . . . , N-M.

Retransmission count control selector 503 selects an appropriate threshold from thresholds preset by the number of times of retransmissions every certain frequency error estimation value range, based on the number of retransmissions 506 from retransmission control section 103 (FIG. 3.)

Selector 502 selects an appropriate threshold from a group of thresholds selected by retransmission count control selector 503, based on frequency error estimation value 505 inputted. For example, when retransmission count control selector 503 selects selector 511 based on the number of times of retransmissions 506, selector 502 selects an appropriate threshold (e.g. threshold 1-2), among thresholds 1-1, 1-2, . . . , 1-M for selector 511, which are selected by retransmission count control selector 503.

Comparator 501 compares received power level estimation value 503 with the threshold selected by selector 502.

As described above, in high-precision transmission channel judgment section 500 with control of the number of times of retransmissions, retransmission count control selector 503 selects an appropriate threshold from thresholds preset by the number of times of retransmissions according to the number of times of retransmissions 506, every certain frequency error estimation value range; selector 502 selects an appropriate threshold from a group of thresholds selected by retransmission count control selector 503, based on frequency error estimation value 505 inputted; and, when received power level estimation value 503 is lower than the selected threshold, comparator 501 outputs an indication that the channel condition is poor.

Therefore, this high-precision transmission channel judgment section 500 with control of the number of times of retransmissions is expected to produce the same effect as in simplified transmission channel judgment section 400 with control of the number of times of retransmissions in FIG. 6, and is able to reduce delay time until arrival more than high-precision transmission channel judgment section 300 in FIG. 5.

The circuit configuration of transmission channel judgment section 110 has been described in detail. Next, a circuit configuration of adaptive scheduler section 108 will be described in detail.

FIG. 8 shows a configuration of a simple version of the above-described adaptive scheduler section 108. Simplified adaptive scheduler section 600 is used as a simple version of adaptive scheduler section 108 in FIG. 3.

In FIG. 8, simplified adaptive scheduler section 600 is composed of scheduler adapter 601, high QoS packet preferential scheduler section 602 and low QoS packet preferential scheduler section 603. In addition, transmission channel condition signal 604 is inputted to scheduler adapter 601.

Scheduler adapter 601 selects output from high QoS packet preferential scheduler section 602 or output from low QoS packet preferential scheduler section 603, based on transmission channel condition signal 604.

High QoS packet preferential scheduler section 602 schedules transmission buffer sections 109-1 to 109-N (FIG. 3) in the order of priority from a transmission buffer section to store a transmission packet associated with a higher QoS service.

Low QoS packet preferential scheduler section 603 schedules transmission buffer sections 109-1 to 109-N (FIG. 3) in the order of priority from a transmission buffer section to store a transmission packet associated with a lower QoS service.

When transmission channel conditions are poor, this simplified adaptive scheduler section 600 can select output from low QoS packet preferential scheduler section 603. This simplified adaptive scheduler 600 has an advantage of allowing adaptive scheduling processing with relatively a little amount of processing.

FIG. 9 shows a circuit configuration of a duplicate transmission version of the above-described adaptive scheduler section 108. Duplicate transmission adaptive scheduler section 700 is used as a duplicate transmission version of adaptive scheduler section 108 in FIG. 3. Here, duplicate transmission adaptive scheduler section 700 has a circuit configuration specific to Embodiment 2 described later (noted here for convenience of explanation.)

In FIG. 9, duplicate transmission adaptive scheduler section 700 is composed of scheduler adapter 701, high QoS packet preferential scheduler section 702 and sequential transmission packet preferential scheduler section 703. In addition, scheduler adapter 701 receives, as input, transmission channel condition signal 704 and sequential transmission buffer evacuation packet delivery acknowledgement signal 705. Sequential transmission packet preferential scheduler section 703 is connected to the outside via communication interface 706.

When a transmission channel condition is judged to be poor based on transmission channel condition signal 704, scheduler adapter 701 switches to output of sequential transmission packet scheduler section 703. In addition, at the time of receiving delivery acknowledgement for an evacuating transmission packet to a plurality of transmission buffers 811 (see FIG. 11 described later), based on sequential transmission buffer evacuation packet delivery acknowledgment signal 705 from retransmission control section 103 (FIG. 3), scheduler adapter 701 switches to high QoS packet preferential scheduler section 702.

High QoS packet preferential scheduler section 702 schedules transmission buffer sections 109-1 to 109-N (FIG. 3) in the order of priority from a transmission buffer section to store a transmission packet associated with a higher QoS service.

Sequential transmission packet preferential scheduler section 703 schedules transmission packets in the order of priority from a transmission packet stored in a sequential transmission buffer (not shown) and evacuates the first transmission packet, among transmission packets associated with preset high QoS services, to the sequential transmission buffer (not shown.)

As described above, scheduler adapter 701 is an adaptive scheduling section that selects output of sequential transmission packet preferential scheduler section 703 when transmission channel conditions are poor. Transmission channel judgment section 103 (FIG. 3) cannot always accurately judge transmission channels. Even if transmission channel judgment section 103 judges that a transmission channel condition is poor, a case is possible where there is no radio error, and in this case, only high QoS service packets are delayed.

In order to prevent this event, even if a transmission channel condition is judged to be poor, high QoS service packets are preferentially scheduled. The same high QoS service packet is redundantly transmitted every transmission opportunity until delivery acknowledgement is received because a radio error is highly likely to occur. By this means, it is possible to reduce delay time until arrival.

However, the same packet can redundantly arrive at the receiver side, so that a duplicate packet discarding mechanism is essential in the receiver side. This is processing is prepared in general HARQ retransmission control because unintended retransmission is likely to occur when a delivery acknowledgement signal has a radio error (although an ACK signal is transmitted from the receiver side, the signal is construed as a NACK signal due to a radio error).

Now, operations of the packet transmitting apparatus configured as described above will be explained.

Packet transmitting apparatus 100 according to the present embodiment is characterized by having adaptive scheduler section 108 and transmission channel judgment section 110. In addition, adaptive scheduler section 108 uses simplified adaptive scheduler section 600 in FIG. 8, or duplicate transmission adaptive scheduler section 700 in FIG. 9. Transmission channel judgment section 110 uses one of transmission channel judgment sections in FIG. 4 to FIG. 7.

In FIG. 3, baseband processing section 102 receives a received signal converted to a digital baseband signal, as input, to estimate radio channel quality.

Transmission channel judgment section 110 judges a transmission channel condition, based on the radio channel quality estimation result from baseband processing section 102.

Adaptive scheduler section 108 selects one of a plurality of scheduling methods, based on the transmission channel condition from transmission channel judgment section 110, and determines transmission frame components. When the transmission channel condition is judged to be poor, adaptive scheduler section 108 preferentially includes low QoS packets in transmission frame components, and, when the transmission channel condition is judged to be good, preferentially includes high QoS packets in transmission frame components.

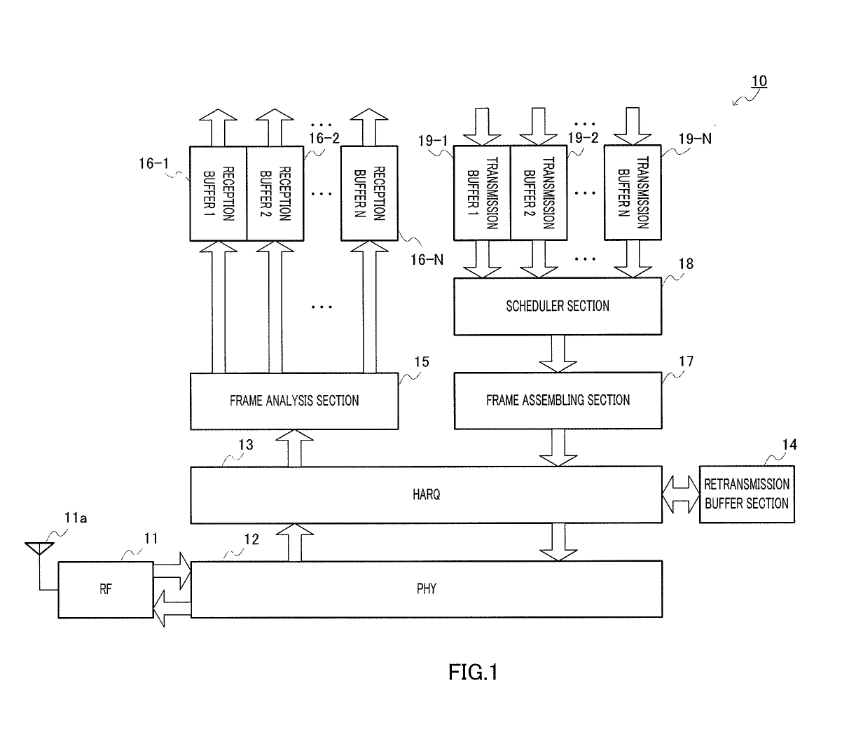

Now, different characteristics and points of adaptive scheduler section 108 from conventional scheduler section 18 (FIG. 1) will be explained.

(1) In the conventional example, scheduler section 18 (FIG. 1) does not take into account transmission channel conditions and has one scheduling algorithm. By contrast with this, adaptive scheduler section 108 selects one of a plurality of scheduling methods, based on the transmission channel condition from transmission channel judgment section 110 and determines transmission frame components.

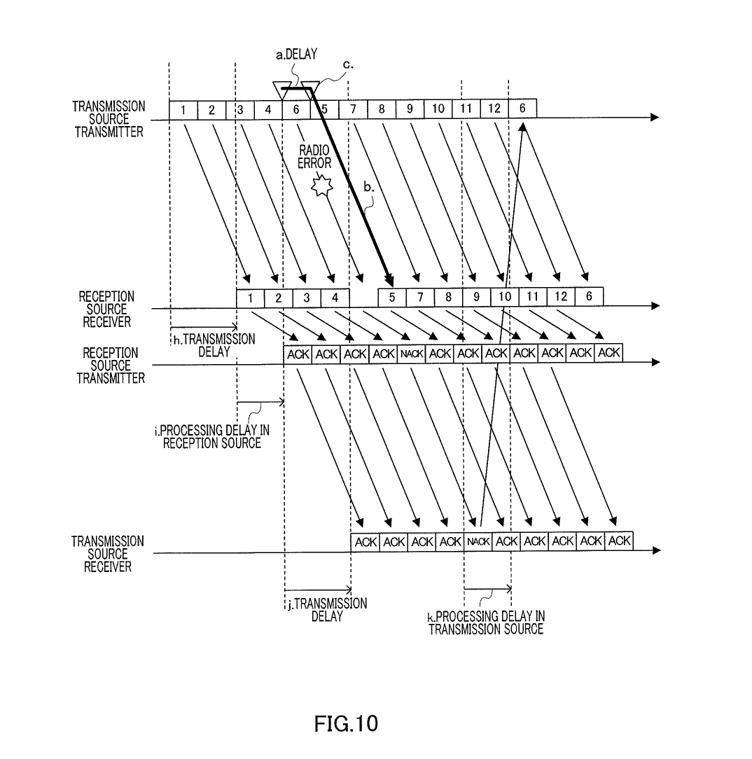

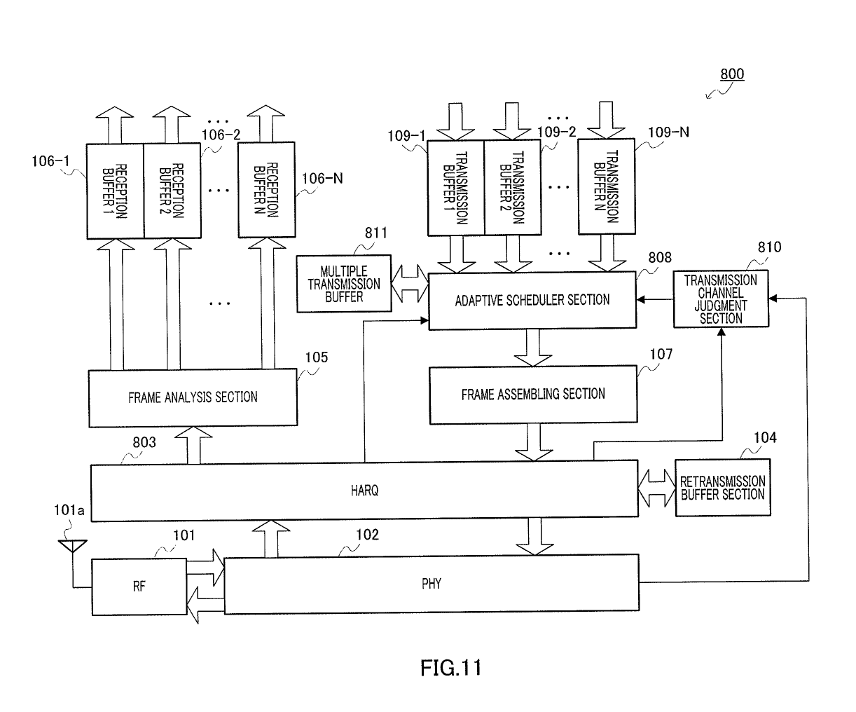

(2) When the transmission channel condition is judged to be poor, adaptive scheduler section 108 preferentially includes low QoS packets in transmission frame components. To be more specific, as shown in following FIG. 10, adaptive scheduler section 108 randomly delays transmission timings when transmission channel conditions are poor. Here, the relationship between “preferentially including low QoS packets in transmission frame components” and “randomly delaying transmission timings” will be explained. An object of the present invention is to provide high QoS maintaining high throughput while minimizing radio errors. Even if a low QoS packet has a radio error, it is possible to minimize the sacrifice of throughput by saving the low QoS packet by HARQ later. In addition, high QoS packets are controlled not to have an error even by randomly delaying high QoS packets.

(3) Transmission timing delay is determined from a following viewpoint. That is, there is a certain level of correlation between a transmission channel condition such as Doppler frequency, and a BER (bit error rate), and, if the transmission channel condition exceeds a certain threshold (is improved), transmission is performed (that is, held until successful transmission is possible.) Assume that control factors are not only transmission channel conditions but also QoS desired to be transmitted, the present invention is characterized in that there are packets influenced and packets not influenced from transmission channel conditions, so that it is possible to maintain both QoS and throughput.

FIG. 10 is a drawing explaining packet transmission delay time when the above-described packet transmitting apparatus 100 is applied. In FIG. 10, numbers on the horizontal axis represent radio frames transmitted from a transmission source transmitter, and radio frames received by a reception source receiver.

In FIG. 10, the transmission source transmitter (packet transmitting apparatus 100) having the configuration shown in FIG. 3 transmits packets.

As shown in FIG. 10a., when transmission channel judgment section 110 judges that a transmission channel condition is poor, adaptive scheduler section 108 judges that a radio error is highly likely to occur and preferentially assigns a low QoS packet. In a case shown in FIG. 10, when transmission channel judgment section 110 judges that a radio error is likely to occur in a fifth radio frame, adaptive scheduler section 108 holds the transmission of the fifth radio frame, transmits (see FIG. 10b.) a sixth radio frame formed by a lower QoS packet than the highest QoS packet of the fifth radio frame, and transmits (see FIG. 10c.) the fifth radio frame at the next synchronous transmission timing at which the transmission channel condition is improved.

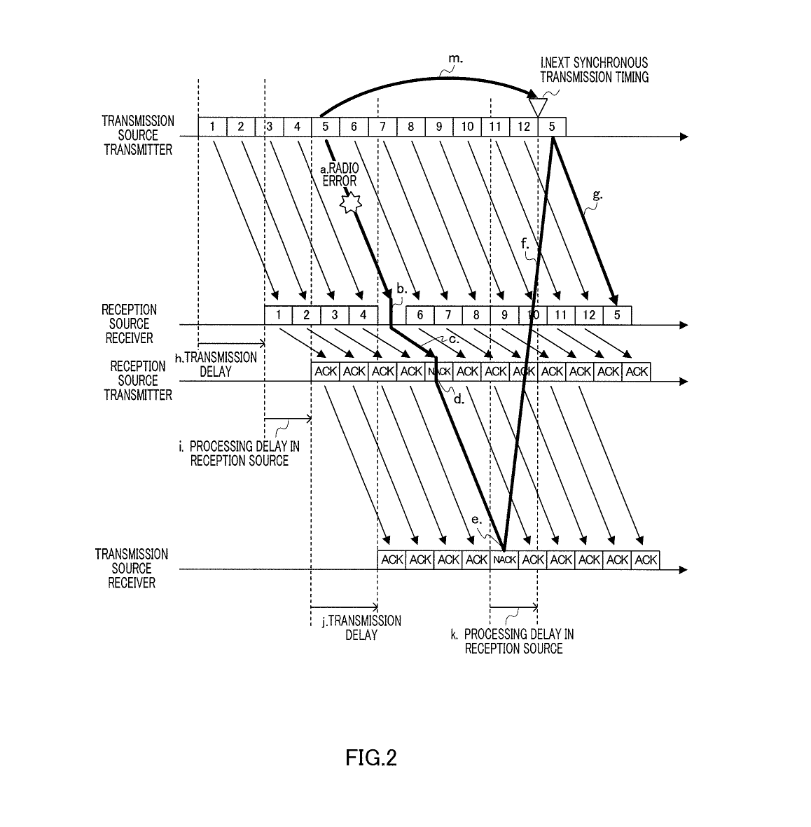

In this process, the total delay time is composed of a radio transmission delay (see FIG. 10h.) to transmit radio frames from the transmission source transmitter to the reception source receiver and a waiting time until the transmission channel condition is improved, and is shorter than in a case in which the conventional packet transmitting apparatus shown in FIG. 2 is used.

That is, in the process according to the present embodiment, the fifth radio frame transmission is delayed as shown in FIG. 10a., the sixth radio frame formed by a lower QoS packet than the highest QoS packet of the fifth radio frame is transmitted (see FIG. 10b.) and the fifth radio transmission frame is transmitted (see FIG. 10c.) at the next synchronous transmission timing at which the transmission channel condition is improved. As shown in FIG. 10c., the fifth radio frame is transmitted at the next synchronous transmission timing at which the transmission channel condition is improved, following the sixth radio frame transmission timing.

In the conventional example, the total processing delay time includes a radio transmission delay (see FIG. 2h.) to transmit radio frames from the transmission source transmitter to the reception source receiver because the next synchronous transmission timing is postponed to the timing of FIG. 2l. as shown in FIG. 2m.; a processing delay in the reception source (see FIG. 2i.) in order that the reception source receiver receives radio frames, performs demodulation and decoding processing, reports the error detection result to the reception source transmitter, generates NACK information and performs coding and modulation processing; a transmission delay (see FIG. 2j.) in order that the reception source transmitter transmits radio frames containing NACK information to the transmission source receiver; and a processing delay in the transmission source (see FIG. 2k.) in order that the transmission source receiver receives radio frames, performs demodulation and decoding processing, detects NACK information and reports the result to transmission source transmitter, and, a waiting time to wait for a synchronous timing is added to the total processing delay time when transmission is performed at the timing in synchronization with the reception source side (see FIG. 2l.). By contrast with this, with the present embodiment, since the fifth radio frame is immediately transmitted at the next synchronous transmission timing (see FIG. 10c.), the above-described total processing delay time and the waiting time are not involved in retransmission processing of the fifth radio frame, so that it is possible to prevent increase in delay time until high QoS packets arrive due to retransmission processing. In a case shown in FIG. 10, the total delay time includes a radio transmission delay to transmit radio frames from the transmission source transmitter to the reception source receiver and the waiting time until the transmission channel is improved, and it is possible to remarkably reduce transmission delay time in the poor radio transmission channel condition.

As described above in detail, in packet transmitting apparatus 100 according to the present embodiment, transmission channel judgment section 110 judges a transmission channel conditions based on the channel quality estimation result, and, when the transmission channel condition is judged to be poor, adaptive scheduler section 108 preferentially include low QoS packets in transmission frame components, and, on the other hand, when the transmission channel condition is judged to be good, adaptive scheduler section 108 preferentially include high QoS packets in transmission frame components. That is, adaptive scheduler section 108 preferentially assigns low QoS packets when judging that a radio error is highly likely to occur and a transmission condition is poor, so that it is possible to prevent retransmission of high QoS packets and also prevent increase in delay time until high QoS packets arrive due to retransmission processing. By this means, it is possible to prevent increase in delay time until high QoS packets arrive and deterioration of communication quality due to radio errors, and it is possible to maintain a low QoS packet transmission rate.

Then, in the feature, when a mobile terminal is anticipated that processes services requiring low delay typified by VoIP (Voice over Internet Protocol) voice call and processes services requiring high transmission rate typified by FTP (File Transfer Protocol) download at the same time, it is possible to assure the quality at the time of retransmission in a poor radio transmission channel condition, that is, it is possible to realize high transmission rate with low delay.

### Embodiment 2

FIG. 11 is a block diagram showing a configuration of a packet transmitting apparatus according to Embodiment 2 of the present invention. The same components as in FIG. 3 are assigned the same reference numerals and overlapping descriptions will be omitted.

In FIG. 11, packet transmitting apparatus 800 is configured to include RF processing section 101, baseband processing section 102, retransmission control section 803, retransmission buffer section 104, frame analysis section 105, reception buffer sections 106-1 to 106-N, frame assembling section 107, adaptive scheduler section 808, transmission buffer sections 109-1 to 109-N, transmission channel judgment section 810 and multiple transmission buffers 811.

RF processing section 101 converts a digital signal radio frame to an analog signal radio frame and sends the result from radio antenna 101a by radio, and converts an analog signal radio frame by radio to a digital signal radio frame. By this means, baseband processing section 102 makes it possible to perform demodulation and decoding processing and receive transmission delivery acknowledgement signals and received packets from a counterpart receiving apparatus.

Baseband processing section 102 (abbreviated as “PHY”) receives, as input, received signals having been converted to digital baseband signals, estimates radio channel quality, performs coding and modulation processing on transmission radio frames and transmits the result by radio.

Retransmission control section 803 (abbreviated as “HARQ”) sends a transmission radio frame from frame assembling section 107, or, when a retransmission request is made, sends a retransmission radio frame from retransmission buffer section 104 to baseband processing section 102 at the time the retransmission radio frame should be transmitted, and holds the retransmission radio frame in transmission buffer section 104 until receiving a delivery acknowledgment from a counterpart receiver.

Frame analysis section 105 analyzes protocol header information of a radio frame in which a received packet is stored, and specifies the position and logical channel information of the received packet.

Reception buffer sections 106-1 to 106-N maintain and accumulate received packets having been specified in frame analysis section 105, in association with logical channel information.

Frame assembling section 107 assembles a radio frame in compliance with a frame format based on transmission frame components determined in adaptive scheduler section 808.

Adaptive scheduler section 808 determines whether or not to change to a multiple transmission preferential scheduling method, based on transmission channel conditions from transmission channel judgment section 810 to evacuate transmission packets to multiple transmission buffers 811, and determines whether or not to change to a high QoS preferential scheduling method, based on delivery information from retransmission control section 803 and determines transmission frame components from transmission buffer sections 109-1 to 109-N. Adaptive scheduler section 808 preferably adopts duplicate transmission adaptive scheduler section 700 shown in FIG. 9.

Transmission buffer sections 109-1 to 109-N maintain and accumulate transmission packets associated with service quality (QoS).

Transmission channel judgment section 810 judges transmission channel conditions, based on radio channel quality estimation results from baseband processing section 102 and the number of times of retransmissions from retransmission control section 803. Transmission channel judgment section 810 preferably adopts high-precision transmission channel judgment section 300 shown in FIG. 5, or high-precision transmission channel judgment section 500 with control of the number of times of retransmissions shown in FIG. 7.

Now, operations of the packet transmitting apparatus configured as described above will be explained.

Packet transmitting apparatus 800 according to the present embodiment is characterized by having adaptive scheduler section 808, transmission channel judgment section 810 and multiple transmission buffers 811. The basic operation of packet transmitting apparatus 800 is the same as in packet transmitting apparatus 100 shown in FIG. 3. The difference is that adaptive scheduler section 808 performs following control using multiple transmission buffers 811.

Adaptive scheduler 808 determines whether or not to change to a multiple transmission preferential scheduling method based on transmission channel conditions from transmission channel judgment section 810 to evacuate transmission packets to multiple transmission buffers 811, and determines whether or not to change to a high QoS preferential scheduling method based on transmission information from retransmission control section 803 and determines transmission frame components from transmission buffer sections 109-1 to 109-N.

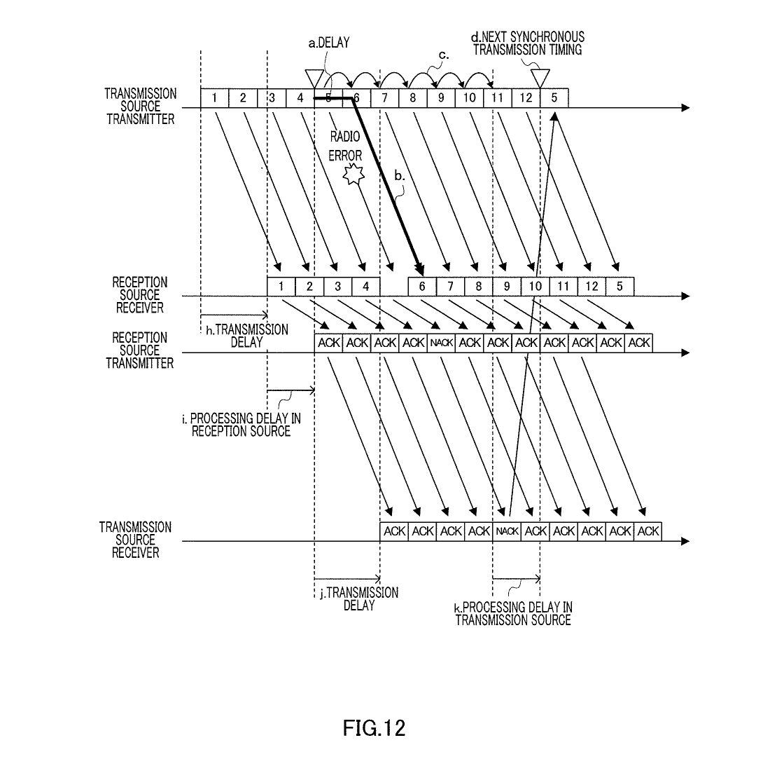

FIG. 12 is a drawing explaining packet transmission delay time when the above-described packet transmitting apparatus 800 is applied. In FIG. 12, numbers on the horizontal axis represent radio frames transmitted from a transmission source transmitter and radio frames received by a reception source receiver.

In FIG. 12, packets are transmitted from the transmission source transmitter (packet transmitting apparatus 800) having the configuration shown in FIG. 11.

As shown in FIG. 12a., when transmission channel judgment section 810 judges that a transmission channel condition is poor, adaptive scheduler section 808 switches the scheduler algorithm to the multiple transmission preferential scheduling method. In a case in FIG. 12, when transmission channel judgment section 810 judges that a radio error is likely to occur in a fifth radio frame, adaptive scheduler section 808 switches the scheduler algorithm to the multiple transmission preferential scheduling method, transmits (see FIG. 12b.) a sixth radio frame formed by a lower QoS packet than the highest QoS packet of the fifth frame and redundantly allocate high QoS packets to radio frames following the fifth frame. That is, as shown in FIG. 12c., the data part of a high QoS packet is copied to each subsequent frame. It is allowed that a plurality of packets (various kinds of QoS) are present in a radio frame. Therefore, only a high QoS packets among a plurality of packets is copied to each subsequent radio frame.

A multiple mode refers to the multiple transmission preferential scheduling method. In addition, in the multiple mode, high QoS packets are redundantly allocated.

Although with Embodiment 1, transmission timings are delayed at random, transmission timings are switched in the multiple mode. Now, the technical relationship, advantage and whether combination is possible, will be explained.

Embodiment 1 represents an aspect in which delays stay within a certain level by randomly delaying. The present embodiment represents an aspect to ensure a reliable success even if throughput is reduced a little. Transmission channel estimation has limitations, and therefore an estimation error may occur. Therefore, the embodiment has arrived at continuing transmitting the same high QoS packet until the condition is improved. By this means, it is possible to expect that high QoS packets are delivered in early stages.

By this means, when the transmission channel judgment section makes an error of judgment and a radio error does not occur, transmission is possible with the shortest delay including only transmission delay, and, even if a radio error occurs, transmission is possible with the same delay time as in FIG. 10. In addition, in order to efficiently use radio bands, generally a radio frame has a frame format to allow multiplexing a plurality of packets and multiplexing packet fragments by packet division, and multiplexing is possible such that only high QoS packets are copied to radio frames following the fifth radio frame in FIG. 12, and low QoS packets are not copied as in a conventional arrangement manner.

The above description is illustration of preferred embodiments of the present invention and the scope of the invention is not limited to this.

Although the names “packet transmitting apparatus” and “packet transmitting method” are used in the above-described embodiments for ease of explanation, “packet communication apparatus”, “mobile terminal”, “radio communication apparatus”, “adaptive transmitting method” and so forth are possible, naturally.

In addition, with the above-described embodiments, although CPUs are used as an example for explanation, hardware, DSP and so forth may be used.

Moreover, the type, the number, the connection method and so forth of each of circuit components constituting the above-described packet transmitting apparatus are not limited to the above-described embodiments.

In addition, the above-explained packet transmitting method may be realized by a program to operate this packet transmitting method. This program is stored in a computer-readable storage medium.

The disclosure of Japanese Patent Application No. 2008-167715, filed on Jun. 26, 2008, including the specification, drawings and abstract, is incorporated herein by reference in its entirety.

### INDUSTRIAL APPLICABILITY

The packet transmitting apparatus and packet transmitting method according to the present invention are used as part of packet transmission processing in mobile telephone for mobile communication. Particularly, in the EDGE scheme centered around Europe, the HSDPA scheme centered around Japan, and the 3G-LTE scheme for next generation mobile communication, it is possible to contribute to improve high QoS services that require high real time performance such as VoIP.

### REFERENCE SIGNS LIST

100, 800 packet transmitting apparatus
101 RF processing section
101a radio antenna
102 baseband processing section
103, 803 retransmission control section
104 retransmission buffer section
105 frame analysis section
106-1 to 106-N reception buffer section
107 frame assembling section
108, 600, 700, 808 adaptive scheduler section
109-1 to 109-N transmission buffer section
110, 200, 300, 400, 500, 810 transmission channel judgment section
201, 301, 401, 501 comparator
302, 402 502 selector
503 retransmission count control selector
601, 701 scheduler adopter
602, 702 high QoS packet preferential scheduler section
603 low QoS packet preferential scheduler section
703 sequential transmission packet preferential scheduler section
811 multiple transmission buffers

1. A packet transmitting apparatus comprising:
a transmission buffer section that accumulates transmission packets associated with service quality (QoS);
a baseband processing section that estimates radio channel quality by demodulation and decoding processing;
a transmission channel judgment section that judges a transmission channel condition, based on a radio channel quality estimation result from the baseband processing section;
an adaptive scheduler section that selects one of a plurality of scheduling methods based on the transmission channel condition from the transmission channel judgment section, and determines transmission frame components in transmission packets accumulated in the transmission buffer section;
a frame assembling section that assembles a radio frame in compliance with a frame format, based on the transmission frame components determined in the adaptive scheduler section; and
a retransmission control section that sends a transmission radio frame from the frame assembling section, or, when a retransmission request is made, sends a retransmission radio frame from a retransmission buffer to the baseband processing section, and holds the transmission radio frame or the retransmission radio frame in the retransmission buffer until receiving a delivery acknowledgement from a counterpart receiver,
wherein, when the transmission channel judgment section judges that the transmission channel condition is poor, the adaptive scheduler section preferentially includes a low service quality packet in the transmission frame components, and, when the transmission channel judgment section judges that the transmission channel condition is good, preferentially includes a high service quality packet in the transmission frame components.

2. The packet transmitting apparatus according to claim 1, wherein the transmission channel judgment section includes a comparator that receives, as input, a received bit error rate estimation value, among radio channel quality estimation results from the baseband processing section and compares the received bit error rate estimation value with a preset threshold, and, when the bit error rate estimation value is higher than the threshold, outputs an indication that the transmission channel condition is poor.

3. The packet transmitting apparatus according to claim 1, wherein the transmission channel judgment section includes a comparator to receive, as input, a frequency error estimation value and a received power level estimation value, among radio channel quality estimation results from the baseband processing section and compare the frequency error estimation value and the received power level estimation value with a preset threshold every predetermined frequency error estimation value range, selects a threshold from the frequency error estimation value, and, when the received power level estimation value is lower than the selected threshold, outputs an indication that the transmission channel condition is poor.

4. The packet transmitting apparatus according to claim 1, wherein the transmission channel judgment section includes a comparator to receive, as input, a received bit error rate estimation value among radio channel quality estimation results from the baseband processing section, and a number of times of retransmissions from the retransmission control section, and compare the received bit error rate estimation value and the number of times of retransmissions with a threshold preset by the number of times of retransmissions, selects a threshold according to the number of times of retransmissions, and, when the received bit error rate estimation value is higher than the selected threshold, outputs an indication that the transmission channel condition is poor.

5. The packet transmitting apparatus according to claim 1, wherein the transmission channel judgment section includes a comparator to receive, as input, a frequency error estimation value and a received power level estimation value among radio channel quality estimation results from the baseband processing section, and a number of times of retransmissions from the retransmission control section, and compare the received power level estimation value, the received power level estimation value and the number of times of retransmissions with a threshold preset every certain frequency error estimation value range by the number of times of retransmissions, selects a threshold based on the frequency error estimation value and the number of times of retransmissions, and, when the received power level estimation value is lower than the selected threshold, outputs an indication that the transmission channel condition is poor.

6. The packet transmitting apparatus according to claim 1, wherein the adaptive scheduling section includes:
a high service quality service preferential scheduling section that schedules transmission buffers in an order of priority from a transmission buffer to store a transmission packet associated with high service quality service;
a low service quality service preferential scheduling section that schedules transmission buffers in the order of priority from a transmission buffer to store a transmission packet associated with low service quality service; and
an adapting section that selects an output from the high service quality service preferential scheduling section and an output from the low service quality service preferential scheduling section, based on the transmission channel condition,
wherein,when the transmission channel condition is poor, the adapting section selects the output from the low service quality service preferential scheduling section.

7. The packet transmitting apparatus according to claim 1, wherein the adaptive scheduling section includes:
a high service quality service preferential scheduling section that schedules transmission buffers in an order of priority from a transmission buffer to store a transmission packet associated with high service quality service;
a sequential transmission buffer section to which transmission buffers are evacuated;
a sequential transmission packet preferential scheduling section that schedules transmission packets in the order of priority from a transmission packet stored in the sequential transmission buffer, and evacuates a first transmission packet, among transmission packets associated with preset high service quality service, to the sequential transmission buffer section; and
an adapting section that switches to an output of the sequential transmission packet preferential scheduling section at a time the transmission channel condition is judged to be poor, and switches to high service quality service preferential scheduling at a time a delivery acknowledgement for the transmission packet being evacuated in the sequential transmission buffer section is received,
wherein the transmission channel condition is poor, the adaptive scheduling section selects the output of the sequential transmission packet preferential scheduling section.

8. A packet transmitting method comprising the steps of:
accumulating transmission packets associated with service quality;
estimating radio channel quality by demodulation and decoding processing;
judging a transmission channel condition based on an estimation result of the radio channel quality;
selecting one of a plurality of scheduling methods based on the transmission channel condition and determining transmission frame components of the transmission packets accumulated, based on the selected scheduling method;
assembling a radio frame in compliance with a frame format based on the determined transmission frame components; and
sending a transmission radio frame, or, when a retransmission request is made, sending a retransmission radio frame, and holding the transmission frame or the retransmission frame in the retransmission buffer until a delivery acknowledgement is received from a counterpart receiver,
wherein,when the transmission channel condition is judged to be poor, a low service quality packet is preferentially included in transmission frame components, and, when the transmission channel condition is judged to be good, a high service quality packet is preferentially included in the transmission frame components.
